(19) United States
(12) Patent Application Publication
(10) Pub. No.: US 2013/0197950 A1
(43) Pub. Date: Aug. 1, 2013

(54) TRAVEL INFORMATION SYSTEM

(71) Applicant: NCR Corporation, Duluth, GA (US)

(72) Inventors: Michael Boyd, Wappingers, NY (US); Chelsea Leigh Redington, Denver, CO (US)

(73) Assignee: NCR Corporation, Duluth, GA (US)

(21) Appl. No.: 13/746,030

(22) Filed: Jan. 21, 2013

Related U.S. Application Data
(60) Provisional application No. 61/593,051, filed on Jan. 31, 2012.

(51) Int. Cl. G06Q 10/02

(52) U.S. Cl. CPC G06Q 10/02
USPC 705/5

(57) ABSTRACT

A travel information system which provides travelers with reaccommodation and other information to make travel easier. An example travel information system includes a computer for determining travel change information from a transportation system, for identifying travelers associated with the travel change information, and for notifying the travelers of the travel change information at a point of travel.

### CROSS-REFERENCE TO RELATED APPLICATIONS

This application claims the benefit of U.S. Provisional Application No. 61/593,051, filed Jan. 31, 2012.

### BACKGROUND

The present invention relates to travel systems, and more specifically to a travel information system.

When trips, such as airline flights, are cancelled or delayed, it impacts both travelers and transportation company personnel. Travelers experience stress and confusion and must wait to be reaccommodated. Transportation company personnel must perform additional work to reaccommodate impacted travelers and experience stress and reduced productivity. Finally, the preferred flow of travelers at transportation locations is disrupted by travelers waiting in lines and bunching in front of departure information displays.

Therefore, it would be desirable to provide a travel information system to reduce disruption for travelers, transportation company personnel, and transportation facilities caused by cancellations, delays, or other changes in transportation schedules.

### SUMMARY

In accordance with the teachings of the present invention, a travel information system is provided.

An example travel information system includes a computer for determining travel change information from a transportation system, for identifying travelers associated with the travel change information, and for notifying the travelers of the travel change information at a point of travel.

For example, the travel information system may send electronic messages to mobile communication devices of the travelers in advance of arrival of the travelers at the point of travel, the messages notifying the travelers of cancellations and rebookings.

As another example, the travel information system may display a passenger list on a display at the point of travel in advance of arrival of the travelers at the point of travel, the traveler list notifying the travelers of cancellations and rebookings and including traveler names, traveler destinations, new transportation departure times, and new transportation departure locations.

### BRIEF DESCRIPTION OF THE DRAWINGS

FIG. 1 is a block diagram of an example travel information system;

FIG. 2 is a flow diagram illustrating an example travel information method;

FIG. 3 is an image of a screen containing information for arriving travelers; and

FIG. 4 is an image of another screen containing information for arriving travelers.

### DETAILED DESCRIPTION

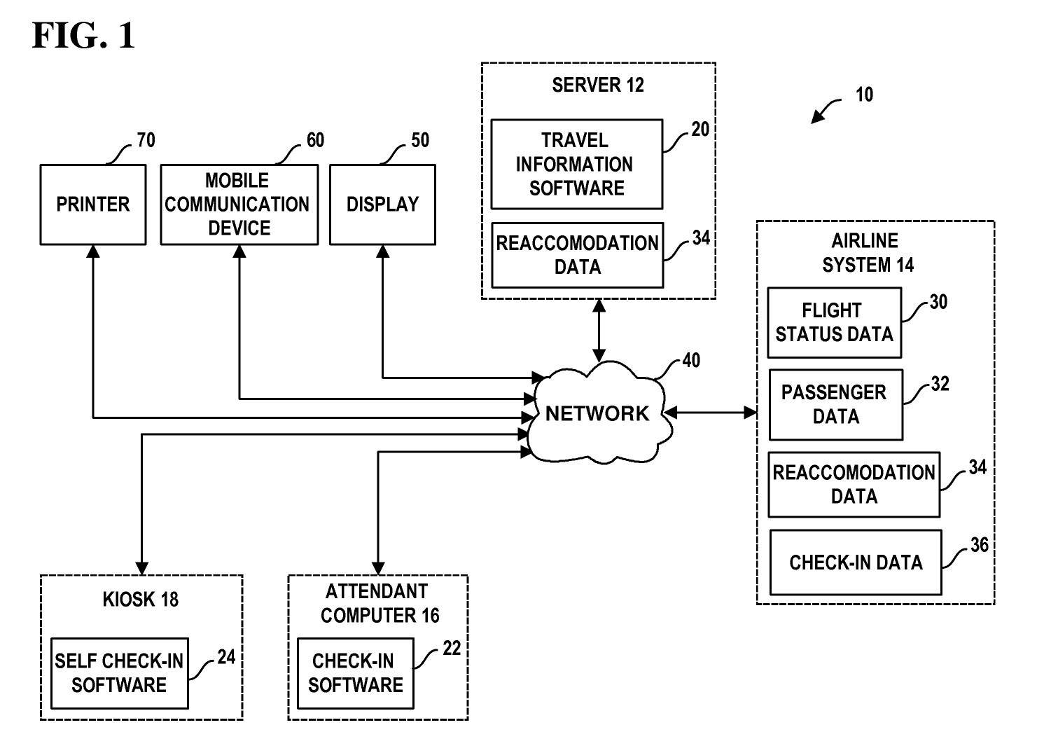

Turning now to FIG. 1, travel information system 10 is illustrated in an air travel example. Other types of transportation methods and corresponding types of travel information are also envisioned.

Example travel information system 10 primarily includes server 12. Server 12 includes a processor, memory, and program and data storage. Server 12 may execute an operating system such as a Microsoft or Linux operating system. Server 12 further includes network circuitry for connecting to network 40, and may include other circuitry for connecting to peripherals, such as a display, a printer, a mouse, and a keyboard. Server 12 may include a web server connected to the World Wide Web (WWW or “web”) and provide web content, including web pages.

Server 12 executes travel information software 20. Travel information software 20 connects to airline systems 14 through network 40. Network 40 may include any combination of wireless or wired networks, including local area, wide area, virtual private, and global communication networks, such as the Internet.

Airline systems 14 maintain databases containing flight and passenger data, including flight status data 30, passenger data 32, and may also maintain flight reaccommodation data 34. Airline systems 14 may include web servers connected to the World Wide Web (WWW or “web”) and provide web content, including web pages. Airline systems 14 may also include third part host computers that store and manage some of the flight and passenger data in a Departure Control System (DCS) for an airline.

Travel information software 20 obtains flight change information, such as cancelled or rescheduled flights and relocation of flights to different departure gates, from flight status data 30. For example, travel information software 20 obtains flight numbers of flights that have been cancelled from flight status data 30.

Travel information software 20 maintains a list of recent flights that have been processed and compares new information from flight status data 30 to the list to filter out previously processed flights.

Travel information software 20 uses the flight change information to obtain passenger manifests associated with changed flights from passenger data 32. For example, travel information software 20 obtains passenger manifests associated with flight numbers of cancelled flights.

Travel information software 20 further obtains or calculates any flight change information that airline systems 14 have made in order to accommodate passengers of changed flights from reaccommodation data 34. For example, travel information software 20 may retrieve data from flight status data 30 and passenger data 32 and calculate reaccomodation data 34. Travel information software 20 may save reaccomodation data 34 in airline system 14, or alternatively, store reaccomodation data 34 locally at server 12.

For example, travel information software 20 obtains new flight information for passengers of cancelled flights. Example new flight information may include a flight number, seat assignment, departure gate and departure time.

As part of the reaccommodation process, airline systems 14 may issue awards, vouchers, or discounts for services, such as food, lodging, and future airline tickets. Travel information software 20 may obtain other information from reaccommodation data 34 directed to such other arrangements for passengers.

Travel information software 20 makes the flight change information available in a variety of ways. For example, travel information software 20 may display the flight change information on a display 50. Display 50 may be located in a service area or other airport location where flight information is displayed. In an example embodiment, display 50 is located at a gate area so that passengers on flights arriving at the gate area can quickly see that connecting flights have been changed, and any available new flight information provided by airline systems 14 to accommodate affected passengers.

Travel information software 20 may send the flight change information directly to display 50 via network 40. Display 50 may include network communication circuitry. Alternatively, display 50 may be connected as a secondary display to another computer, such as attendant computer 16. For example, travel information software 20 may send the flight change information to display 50 via network 40 and attendant computer 16. Another possibility is a multimedia player device which receives the data and displays it on one or more displays 50.

As another example, travel information software 20 sends the flight change information to printer 70 via network 40. Printer 70 prints the flight change information. Printer 70 may be located at a service area, such as a gate area. In an example embodiment, gate attendants use printed reports containing flight change information to announce the flight change information to passengers arriving at gates where the attendants are located.

Travel information software 20 may send the flight change information directly to printer 70 via network 40. For this purpose, printer 70 may include network communication circuitry. Alternatively, printer 70 may be connected to another computer, for example, attendant computer 16. For example, travel information software 20 may send the flight change information to printer 70 via network 40 and attendant computer 16.

Since each gate may include a display 50 and/or a printer 70, travel information software 20 displays and/or prints only connecting flight information for passengers arriving at a specific concourse gate where each display 50 and/or printer 70 is located.

As another example, travel information software 20 may send via network 40, including message aggregators, messages or alerts addressed to passengers with mobile communication devices 60, such as smart phones, containing the flight change information, including but not limited to electronic mail (e-mail) messages and Short Message Service messages (text messages). Passengers with mobile communication devices 60 may sign up with individual airlines to receive these messages by connecting to a website of airline systems 14. Airline systems 14 may save and maintain passenger preferences in user profiles.

Attendant computer 16 executes check-in software 22. Attendant computer 16 may be located at a departure/arrival location. Check-in software 22 may be used by an attendant to print a new boarding pass for a passenger who was notified of a flight change for the new flight, and to service passengers whose flights were cancelled but who have not been reaccomodated.

Kiosk 18 executes self check-in software 24. Kiosk 18 may be located at a departure/arrival location. Self check-in software 24 may be used by a passenger who was notified of a flight change to print a new boarding pass.

Check in software 22 and 24 connect via network 40 to check-in data 36 to complete their check-in functions.

Passengers with mobile communication devices 60 may log into airline system 14, or an intermediary third party boarding pass service, to checkin for the new flight and download a mobile boarding pass. Mobile communication devices 60 may be equipped with a check-in application, similar to check-in software 22 and 24, and/or web browser software for downloading and displaying web pages from airline systems 14 to facilitate downloading of mobile boarding passes. Passengers with mobile communication devices 60 may alternatively check-in via self check-in software 24.

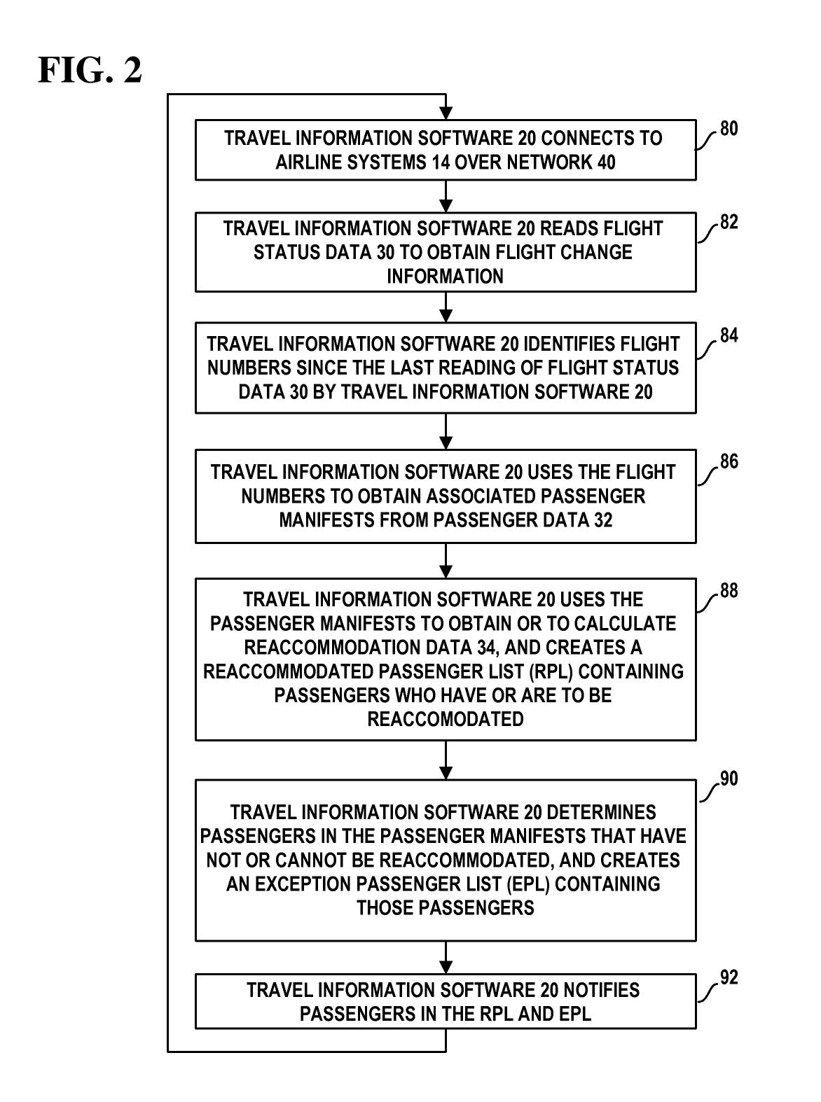

With reference to FIG. 2, an example travel information method is illustrated.

In step 80, travel information software 20 connects to airline systems 14 over network 40.

In step 82, travel information software 20 reads flight status data 30 to obtain flight change information, including but not limited to, flight numbers of cancelled flights.

In step 84, travel information software 20 identifies flight numbers since the last reading of flight status data 30 by travel information software 20. Travel information software 20 compares the flight numbers from flight status data 30 to a list of flight numbers that travel information software 20 has previously processed.

In step 86, travel information software 20 uses the flight numbers to obtain associated passenger manifests from passenger data 32.

In step 88, travel information software 20 uses the passenger manifests to obtain or to calculate reaccommodation data 34, and creates a Reaccommodated Passenger List (RPL) containing passengers who have or are to be reaccomodated.

In step 90, travel information software 20 determines passengers in the passenger manifests that have not or cannot be reaccommodated, and creates an Exception Passenger List (EPL) containing those passengers.

In step 92, travel information software 20 notifies passengers in the RPL and EPL. For example, travel information software 20 may cause display 50 to display the RPL and the EPL, and/or may cause printer 70 to print the RPL and the EPL. As another example, travel information software 20 may determine which passengers have opted in to receiving flight change messages and send flight change messages to passengers with mobile communication devices 60. Passengers may find out more information and redeem any earned vouchers or awards by using kiosk 18 or by asking an attendant at attendant computer 16.

Operation loops back to step 80 to continuously monitor for flight changes.

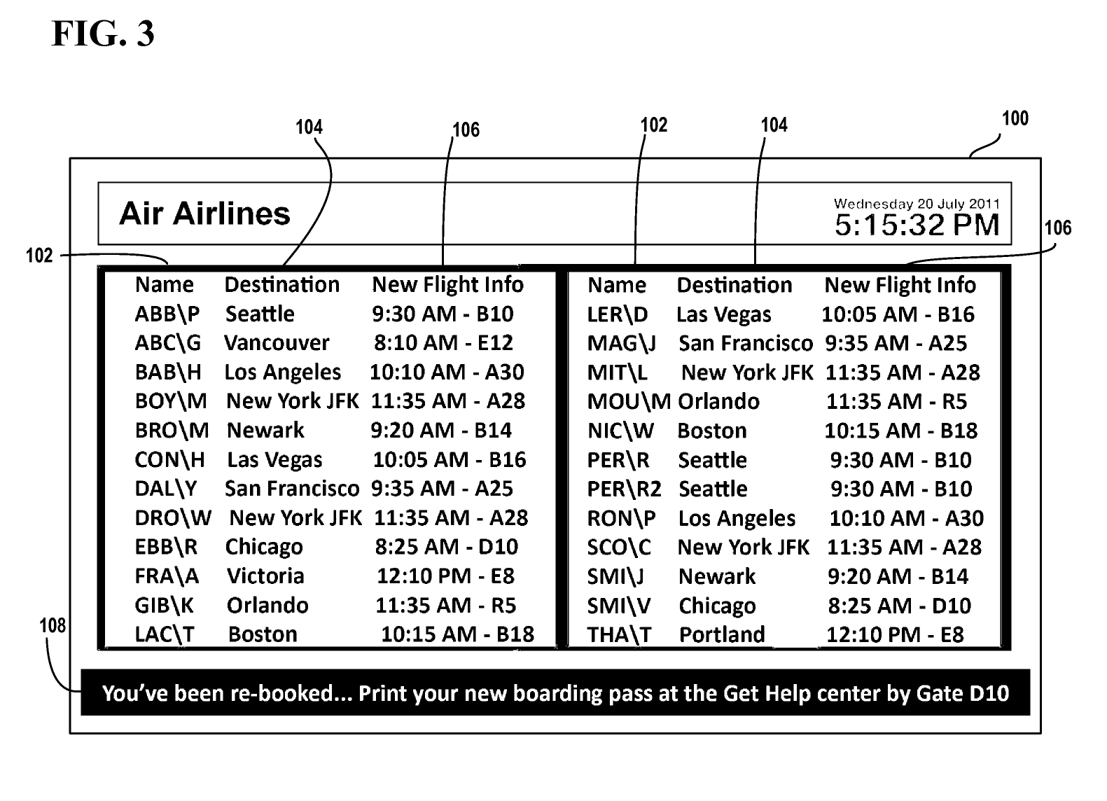

With reference to FIG. 3, an example image of a screen 100 displayed by display 50 is illustrated. Screen 100 notifies reaccommodated passengers of flight changes. For this purpose, screen 100 includes an RPL which travel information software 20 updates in real-time. The RPL only includes passengers that have already been automatically reaccommodated or rebooked with a modified itinerary by their airlines. The RPL includes, but is not limited to, passenger name information 102, destination information 104, and new connecting flight information 106. New connecting flight information 106 may include departure gate and departure time.

Screen 100 may also include a message 108 suggesting that passengers go to kiosk 18 to obtain detailed information.

Passenger name information 102 may include an abbreviated passenger name containing the first three letters of the passenger's last name, a delimiter, and the first letter of the first name. Delimiters may include a back slash, forward slash, or other character based upon airline design standards. Should there be more than one passenger on the RPL with the same abbreviated passenger name; travel information software 20 may append a sequential number to the abbreviated passenger name to distinguish them. Travel information software 20 may alphabetically sort the RPL by abbreviated passenger name.

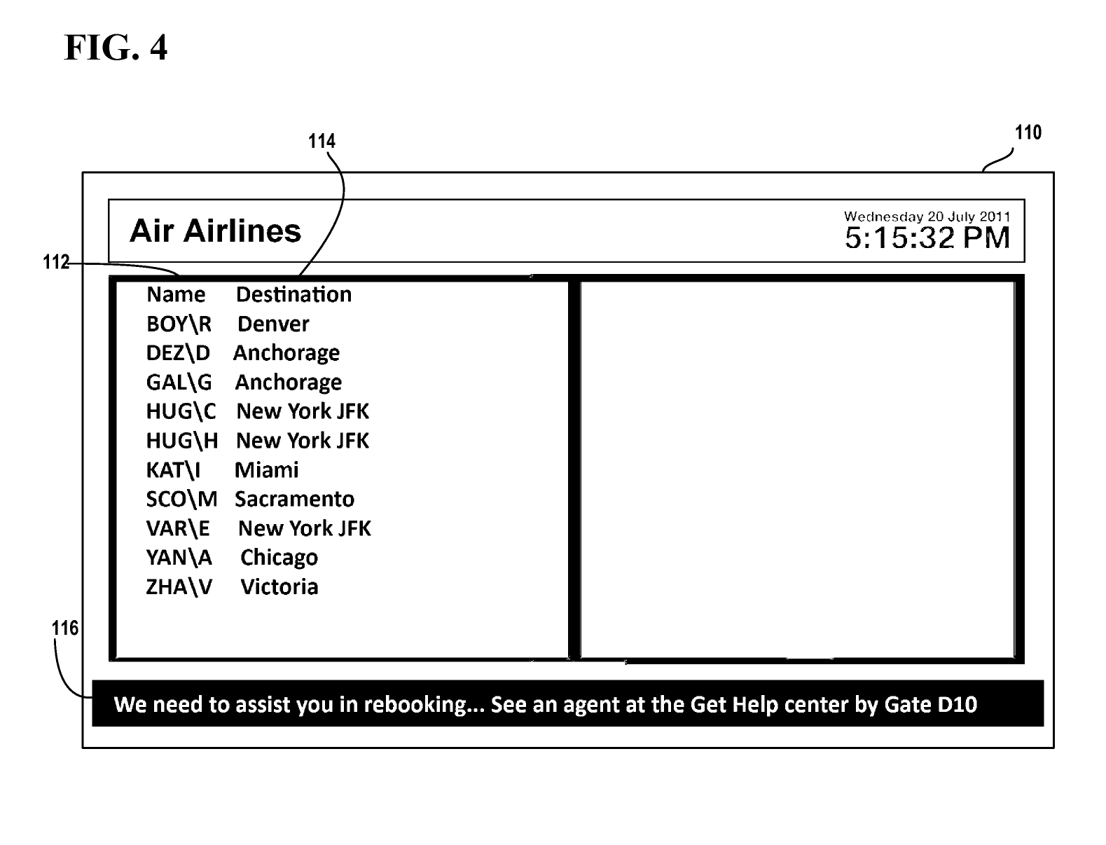

Travel information software 20 may display the RPL using multiple columns. In the case there is more information than would fit on a single screen, travel information software 20 displays additional pages of the RPL in additional screens 100 after a pre-defined time period. After the final page of the RPL and the passage of a pre-defined time period, travel information software 20 displays the next screen. If there are exception passengers, the next screen may include screen 110 of FIG. 4.

With reference to FIG. 4, an example image of a screen 110 displayed by display 50 is illustrated. Screen 110 notifies passengers that have not already been automatically reaccommodated by their airline, or cannot be automatically reaccommodated by their airline, and to see an airline representative to be manually reaccommodated. For this purpose, screen 110 includes an EPL which travel information software 20 updates in real-time.

The EPL may contain, but not be limited to, passenger name information 112 and destination information 114. Passenger name information 112 may include an abbreviated passenger name containing the first three letters of the passenger's last name, a backwards slash and the first letter of the first name. Should there be more than one passenger on the EPL with the same abbreviated passenger name; travel information software 20 may append a sequential number to the abbreviated passenger name to distinguish them. Travel information software 20 may alphabetically sort the EPL by abbreviated passenger name.

Screen 110 may also include a message 116 suggesting that passengers go to an attendant computer 16 to have an agent manually reaccommodate them.

Travel information software 20 may display the EPL using multiple columns. In the case there is more information than would fit on a single screen, travel information software 20 displays additional pages of the EPL in additional screens 110 after a pre-defined time period. After the final page of the EPL and the passage of a pre-defined time period, travel information software 20 displays the next screen.

In addition to the RPL and EPL, travel information software 20 may display one or more screens containing connecting flight information status for all passengers arriving at a particular gate. Travel information software 20 may display the connecting flight information status screen(s) initially, and/or in sequence with, the RPL and EPL in FIGS. 3 and 4.

The connecting flight information status screen may include a list of destination cities and corresponding flight information. The connecting flight information status screen may also contain directions from the current gate to the location of kiosks 18.

The list may be sorted in alphabetical order based on the destination city name. The list may include additional details of specific flights, including but not limited to, flight number, departure gate, departure time, and current flight status. The list may be displayed using multiple columns. In the case there is more information than would fit on a single page, additional pages of connecting flight information may be displayed after a pre-defined time period of displaying a first page of the list.

After the final page of the connecting flight information status and the passage of a pre-defined time period, travel information software 20 may display flight reaccommodation information in FIGS. 3 and 4. If there are no reaccommodated passengers and no exception passengers or no reaccommodation events, travel information software 20 may continue to display the final page of the connecting flight information. If there are reaccommodated passengers, travel information software 20 will display the RPL of FIG. 3 next. If there are no reaccommodated passengers, but there are exception passengers, travel information software 20 will display the EPL of FIG. 4 next. If there are no exception passengers, travel information software 20 displays the connecting flight information status screen.

Advantageously, travel information system provides passengers with reaccommodation and other information to make travel easier for both passengers and airlines.

Although the present invention has been described with particular reference to certain preferred embodiments thereof, variations and modifications of the present invention can be effected within the spirit and scope of the following claims.

What is claimed is:

1. A travel information system comprising:
a computer for determining travel change information from a transportation system, for identifying travelers associated with the travel change information, and for notifying the travelers of the travel change information at a point of travel.

2. The system of claim 1, wherein the travel change information comprises cancellations.

3. The system of claim 1, wherein the travel change information comprises transportation rebookings.

4. The system of claim 1, wherein the travel change information comprises traveler names, traveler destinations, new transportation departure times, and new transportation departure locations.

5. The system of claim 1, wherein the computer determines the travel change information from transportation status data of the transportation system.

6. The system of claim 1, wherein the computer identifies the travelers from traveler data of the transportation system.

7. The system of claim 1, wherein the computer sends electronic messages to mobile communication devices of the travelers.

8. The system of claim 7, wherein the electronic messages comprise electronic mail (e-mail) messages.

9. The system of claim 7, wherein the electronic messages comprise simple message service (sms) messages.

10. The system of claim 1, wherein the computer displays a traveler list on a display at the point of travel.

11. The system of claim 1, wherein the computer prints a report for a travel attendant at the point of travel.

12. The system of claim 3, wherein the computer is also for directing the travelers to check in for the rebookings at self check-in kiosks at departure locations.

13. The system of claim 3, wherein the computer is also for directing the travelers to check in for the rebookings at attended check-in stations at departure locations.

14. The system of claim 2, wherein the computer is also for directing the travelers to travel attendant locations for reaccomodation.

15. A travel information system comprising:
a computer for determining transportation cancellations and rebookings from transportation status data of a transportation system, for identifying travelers associated with the transportation cancellations and rebookings, and for sending electronic messages to mobile communication devices of the travelers in advance of arrival of the travelers at a point of travel, wherein the messages notify the travelers of the cancellations and rebookings.

16. A travel information system comprising:
a computer for determining transportation cancellations and rebookings from transportation status data of a transportation system, for identifying travelers associated with the transportation cancellations and rebookings, and for displaying a passenger list on a display at a point of travel in advance of arrival of the travelers at the point of travel, wherein the traveler list includes traveler names, traveler destinations, new transportation departure times, and new transportation departure locations.

17. A travel information method comprising:
obtaining transportation status data from transportation computer systems, the transportation status data including cancelled transportation data by a travel information computer;
determining travelers associated with the cancelled transportation data in traveler data from the transportation computer systems by the travel information computer;
determining reaccommodation data for a number of the travelers of cancelled transportation by the travel information computer; and
notifying the travelers of the cancelled transportation and notifying the number of travelers of the reaccomodation data at a point of travel in advance of arrival of the travelers at the point of travel by the travel information computer.

18. The method of claim 17, wherein notifying comprises:
creating a list of the number of travelers;
determining which of the number of travelers have opted in to receive messages via mobile communication devices; and
sending the messages to the mobile communication devices, the messages including the cancelled transportation data and the reaccomodation data.

19. The method of claim 17, wherein notifying comprises:
creating a list of other travelers for which no reaccomodation data has been determined;
determining which of the other travelers have opted in to receive messages via mobile communication devices; and
sending the messages to the mobile communication devices, the messages including the cancelled transportation data and instructions to contact a travel representative.

20. The method of claim 17, wherein notifying comprises:
creating a first list of the number of travelers;
creating a second list of other travelers for which no reaccomodation data has been determined;
displaying the first list in a first display screen at the point of travel with the reaccomodation data; and
displaying the second list in a second display screen at the point of travel with an instruction to contact a travel representative.
